(19) United States
(12) Patent Application Publication
(10) Pub. No.: US 2024/0286033 A1
(43) Pub. Date: Aug. 29, 2024

(54) CONTROL METHOD AND CONTROL APPARATUS FOR SPORTS VEHICLE IN GAME, DEVICE, AND MEDIUM

(71) Applicant: NetEase (Hangzhou) Network Co., Ltd., Hangzhou (CN)

(72) Inventors: Lintao LV, Hangzhou (CN); Weidong ZHANG, Hangzhou (CN)

(21) Appl. No.: 18/573,411

(22) PCT Filed: Sep. 14, 2022
(86) PCT No.: PCT/CN2022/118759

§ 371 Date: Dec. 21, 2023

(30) Foreign Application Priority Data
May 11, 2022 (CN) 202210514107.2

(51) Int. Cl. A63F 13/422; A63F 13/2145; A63F 13/57; A63F 13/79; A63F 13/803; A63F 13/92; G06N 3/092

(52) U.S. Cl. CPC A63F 13/422; A63F 13/2145; A63F 13/57; A63F 13/79; A63F 13/803; A63F 13/92; G06N 3/092; A63F 2300/308

(57) ABSTRACT

A method for controlling a motion vehicle in a game is provided. The method includes: obtaining a direction adjustment instruction issued by the target player for the motion vehicle, and running data of the motion vehicle in real time; inputting the direction adjustment instruction and the running data into a trained action prediction model to predict a reward value of each action executed by the motion vehicle; selecting a target action from a plurality of actions according to a historical operation habit of the target player and the reward value of each action; and controlling the motion vehicle to execute the target action in the game scene. Various related systems and devices are also provided.

### CROSS-REFERENCE TO RELATED APPLICATIONS

The present disclosure is the U.S. National Stage Application of PCT International Application No. PCT/CN2022/118759, filed on Sep. 14, 2022, which is based upon and claims the priority to the Chinese patent application with the filing No. 202210514107.2, filed on May 11, 2022, entitled “Controlling Method and Controlling Apparatus for Motion Vehicle in Game, Device, and Medium”, the entire contents of both of which are incorporated by reference herein for all purposes.

### TECHNICAL FIELD

The present disclosure relates to the field of game control, and in particular to a controlling method and controlling apparatus for a motion vehicle in a game, a device, and a medium.

### BACKGROUND

With the development of technologies and the improvement of mobile device performance, online games have gradually entered people's lives. Among them, online racing games are chosen by more and more players because of the exciting experience in speed. However, racing games often focus more on reaction speed such that players may easily fail at these games if they are not trained. Therefore, in order to allow novice players to adapt to racing games as soon as possible, the game may provide an automatic mode to provide players with more training, thus improving the adaptation of players to the game.

### SUMMARY

In some aspects, the present disclosure provides a method for a motion vehicle in a game, including: obtaining, by a terminal, a direction adjustment instruction issued by a target player for the motion vehicle, and running data of the motion vehicle in real time, where a graphical user interface is provided through the terminal, and at least a part of a game scene and the motion vehicle controlled by the target player in the game scene are displayed in the graphical user interface; inputting the direction adjustment instruction and the running data into a trained action prediction model to predict a reward value of each action executed by the motion vehicle; selecting a target action from a plurality of actions according to a historical operation habit of the target player and the reward value of each action; and controlling the motion vehicle to execute the target action in the game scene.

In some aspects, the present disclosure provides a computer device, including a memory, a processor, and a computer program stored on the memory and executable by the processor, where the processor is configured for performing steps including obtaining a direction adjustment instruction issued by the target player for the motion vehicle, and running data of the motion vehicle in real time, where a graphical user interface is provided through the computer device, and at least a part of a game scene and the motion vehicle controlled by a target player in the game scene are displayed in the graphical user interface; inputting the direction adjustment instruction and the running data into a trained action prediction model to predict a reward value of each action executed by the motion vehicle; selecting a target action from a plurality of actions according to a historical operation habit of the target player and the reward value of each action; and controlling the motion vehicle to execute the target action in the game scene.

In some aspects, the present disclosure provides a non-transitory computer-readable storage medium, where a computer program is stored on the non-transitory computer-readable storage medium, and when the computer program is run by a processor, the processor performs steps for controlling a motion vehicle in a game, the steps including: obtaining, by a terminal, a direction adjustment instruction issued by the target player for the motion vehicle, and running data of the motion vehicle in real time, where a graphical user interface is provided through the terminal, and at least a part of a game scene and the motion vehicle controlled by a target player in the game scene are displayed in the graphical user interface; inputting the direction adjustment instruction and the running data into a trained action prediction model to predict a reward value of each action executed by the motion vehicle; selecting a target action from a plurality of actions according to a historical operation habit of the target player and the reward value of each action; and controlling the motion vehicle to execute the target action in the game scene.

### BRIEF DESCRIPTION OF DRAWINGS

The accompanying drawings illustrate a number of exemplary embodiments and are a part of the specification and are not limiting. Together with the following description, these drawings demonstrate and explain various principles of the present disclosure.

FIG. 1 is a schematic flowchart of a method for controlling a motion vehicle in a game provided by one or more embodiments of the present disclosure;

FIG. 2 is a schematic flowchart of a method for training an action prediction model provided by one or more embodiments of the present disclosure;

FIG. 3 is a structural schematic diagram of a apparatus for controlling a motion vehicle in a game provided by one or more embodiments of the present disclosure; and

FIG. 4 is a structural schematic diagram of a computer device provided by one or more embodiments of the present disclosure.

### DETAILED DESCRIPTION

In order to make the objective, technical solutions and advantages of the embodiments of the present disclosure clearer, the technical solutions in the embodiments of the present disclosure will be clearly and completely described below with reference to the drawings in the embodiments of the present disclosure. In addition, the described embodiments describe some rather than all of the embodiments of the present disclosure. Generally, the components of the embodiments of the present disclosure described and illustrated in the drawings herein may be arranged and designed in various different configurations. Therefore, the following detailed description of the embodiments of the present disclosure provided in the drawings is not intended to limit the claimed scope of protection of the present disclosure, but only represents selected embodiments of the present disclosure. Based on the embodiments of the present disclosure, all other embodiment obtained by those skilled in the art without making creative efforts shall fall within the scope of protection of the present disclosure.

Reference will now be described in detail to examples, which are illustrated in the drawings. The following description refers to the drawings in which the same numbers in different drawings represent the same or similar elements unless otherwise represented. The examples described following do not represent all examples consistent with the present disclosure. Instead, they are merely examples of devices and methods consistent with aspects of the present disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment”, “an embodiment”, “an example”, “some embodiments”, “some examples” or similar language means that a particular feature, structure or characteristic described is included in at least one embodiment or example. Features, structures, elements, or characteristics described in connection with one or some embodiments are also applicable to other embodiments, implementations, and/or examples, unless expressly specified otherwise.

The term “and/or” in the present application indicates only an association relationship describing associated objects, meaning that there may be three kinds of relationships. For example, A and/or B may indicate three situations: there is only A, there are both A and B, and there is only B.

In some examples, in the manual mode of an online racing game, direction controls (a left direction control and a right direction control) and a drifting control may be provided in the graphical user interface of the terminal. The player can touch the direction control to send a direction adjustment instruction to the motion vehicle to make the motion vehicle adjust the direction in the game scene, and touch the drifting control to send a drifting instruction to the motion vehicle to make the motion vehicle complete a drifting action in the game scene. In an automatic mode of the online racing game, only the direction controls are provided in the graphical user interface of the terminal, and the player can touch the direction control to send the direction adjustment instruction to the motion vehicle, so that the motion vehicle can adjust its direction according to the direction adjustment instruction, where whether the motion vehicle needs to execute the drifting action needs to be determined by a behavior tree in the system according to the current running data of the motion vehicle and the direction adjustment instruction sent by the player for the motion vehicle.

In some examples, whether the motion vehicle needs to execute the drifting action in the automatic mode can be determined by using a behavior tree algorithm in the system. However, in the traditional game control mode using the behavior tree algorithm, because the parameters and the structure in the behavior tree may be set artificially and uniformly, there may be a lack of interactivity with the player, such that the player's intention cannot be accurately identified, and thus resulting in the situation of inaccurate control of the motion vehicle. Embodiments of the present disclosure provide a method and apparatus for controlling a motion vehicle in a game, and further provide a related device, and a related medium, which are described below by the embodiments.

In one embodiment of the present disclosure, the method for controlling a motion vehicle in a game may be run on a local terminal or a server. When the method for controlling a motion vehicle in a game is run on the server, the method may be implemented and performed based on the cloud interaction system, where the cloud interaction system includes the server and a client.

In some examples, various cloud applications, such as cloud gaming, may be run in the cloud interactive system. Taking the cloud gaming as an example, the cloud gaming refers to a game mode based on cloud computing. In the running mode of cloud gaming, the running subject of the game program and the presenting subject of game scenes are separated, and the storage and running of the controlling method for a motion vehicle in a game is completed on the cloud gaming server. The role of the client is to receive and send data and present game scenes. For example, the client may be a display device with data transmission function, close to the user side, such as a mobile terminal, a TV, a computer, a personal digital assistant (PDA), etc. However, the information processing is performed by a cloud gaming server in the cloud. When playing a game, the player operates the client to send an operation instruction to the cloud gaming server. The cloud gaming server runs the game according to the operation instruction, encodes and compresses the data such as game scenes, and returns the same to the client through the network. Finally, the client decodes and outputs the game scenes.

In some examples, taking the game as an example, the local terminal stores the game program and is configured for presenting the game scenes. The local terminal is configured for interacting with the player through the graphical user interface, that is, the game program is conventionally downloaded, installed and run through the electronic device. The local terminal may provide the graphical user interface to the player in various ways. For example, it may be rendered and displayed on a display screen of the terminal, or it may be provided to the player through holographic projection. For example, the local terminal may include a display screen and a processor, where the display screen is configured for presenting a graphical user interface which includes a game scene, and the processor is configured for running the game, generating the graphical user interface, and controlling the display of the graphical user interface on the display screen.

The present disclosure is illustrated with the method for controlling a motion vehicle in a game being performed on a terminal, where the terminal is an electronic device with a touch function, such as a smart phone. A graphical user interface is provided through the terminal. The graphical user interface refers to the interface rendered on the display screen of the terminal and used for human-computer interaction. The game of the present disclosure includes a game scene, and a target virtual character and/or a motion vehicle in the game scene, and the content displayed in the graphical user interface further includes a game scene, which may be a game scene of a part of the game scene. The terminal can control the target virtual character and/or the motion vehicle to execute a virtual action in the game scene, such as moving in the game scene or releasing skills, in respond to the touch operation acting on the operation area in the graphical user interface. The game scene may include any one or more of the following game elements: landforms, mountains and rocks, flowers and plants, rivers, buildings, virtual objects, game props, etc. In general, a virtual camera is arranged in the game scene, and the game scene displayed on the graphical user interface is a part of the game scene shot by the virtual camera. For example, in the first-person game, the virtual camera may be arranged at the head (for example, at the eye position) of the target virtual character controlled by the player or near the front window of the motion vehicle (for example, at the rearview mirror position). The virtual camera moves with the movement of the target virtual character and/or the motion vehicle, and the orientation of the virtual camera rotates with the rotation of the virtual subject (the target virtual character and/or the motion vehicle). Therefore, the game scene presented on the graphical user interface is a part of the game scene in the preset range in front of the target virtual character and/or the motion vehicle. The graphical user interface includes a part of the game scene. For another example, in a third-person game, the virtual camera may be arranged directly above or above the rear of the target virtual character and/or the motion vehicle controlled by the player, so the game scene presented on the graphical user interface is a part of the game scene, including the target virtual character and/or the motion vehicle. If the account of a target player is logged in on the terminal, the target virtual character and/or the motion vehicle are controlled by the terminal. The virtual object is a dynamic object that can be controlled in a virtual scene. In some examples, the dynamic object may be a virtual character, a virtual animal, an animated character, etc. The target virtual character is a character controlled by the player through the terminal, or Artificial Intelligence (AI) arranged, by training, in a virtual environment battle, or a non-player character (NPC) arranged in a virtual scene battle. In some examples, the target virtual object is a virtual character competing in the virtual scene.

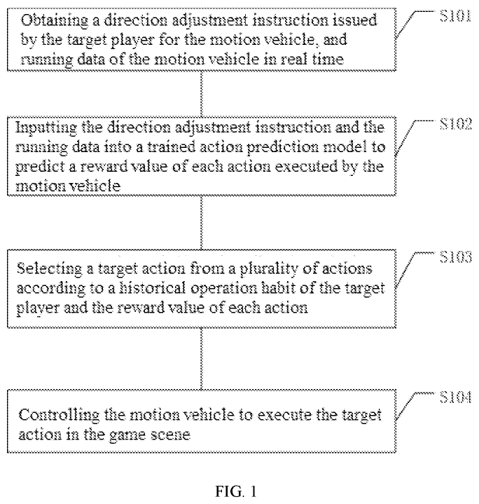

To address technical problems of related technologies as described herein, embodiments of the present disclosure provide a method for controlling a motion vehicle in a game, where a graphical user interface is provided through a terminal, the terminal may be the aforementioned local terminal or a client. The graphical user interface includes at least a part of the game scene and a motion vehicle controlled by the target player in the game scene. As shown in FIG. 1, the method may include the following steps:
S101: obtaining a direction adjustment instruction issued by the target player for the motion vehicle, and running data of the motion vehicle in real time;
S102: inputting the direction adjustment instruction and the running data into a trained action prediction model to predict a reward value of each action executed by the motion vehicle;
S103: selecting a target action from a plurality of actions according to a historical operation habit of the target player and the reward value of each action; and
S104: controlling the motion vehicle to execute the target action in the game scene.

In the above step S101, the motion vehicle is a prop that is configured for carrying a virtual character in the game scene and being controlled by the player to move in the game scene, or a prop that is configured for not carrying a virtual character and being controlled by the player to move in the game scene. For example, the motion vehicle may be a car prop. The running data of the motion vehicle includes any one or more of the following data: the position in the game scene, the moving speed, the moving angular speed, the moving acceleration, etc. The direction adjustment instruction is an instruction generated after the target player touches the direction adjustment control in the graphical user interface and configured to control the moving direction of the motion vehicle. The direction adjustment controls include a left-turning direction adjustment control and a right-turning direction adjustment control, and the direction adjustment instruction may be a left-turning direction adjustment instruction or a right-turning direction adjustment instruction.

In one or more embodiments, after the game scene in the automatic mode is entered and the target player starts to control the movement of the motion vehicle in the game scene, the terminal may obtain the direction adjustment instruction issued by the target player for the motion vehicle, and running data of the motion vehicle in real time. In the above, the motion vehicle may be in a moving state of going straight in the game scene, and the target player does not need to control its direction. Therefore, although the direction adjustment instruction issued by the target player for the motion vehicle are obtained in real time, it is not always possible to obtain the direction adjustment instruction.

In the above step S102, the action includes any one of the following actions: drifting and non-drifting. Among them, the drifting is a driving skill of the motion vehicle in the game scene. The reward value of each action that the motion vehicle executes refers to the reward or value that the motion vehicle can bring after executing the action in the game scene. In the above, the larger the reward value of the action is, the larger the probability of the motion vehicle executing the action is, and the smaller the reward value of the action is, the smaller the probability of the motion vehicle executing the action is. The trained action prediction model is obtained by training with a large amount of training data. Since the historical data of one player playing the game is relatively less, in order to improve the accuracy of prediction, it is necessary to obtain a large amount of training data to train the action prediction model. Therefore, a large amount of training data may be composed of historical data of a plurality of players playing the game. In different game maps, the environmental factors in the game scene may have an impact on the running data of the motion vehicle, and also have an impact on the direction adjustment instruction issued by the target player for the motion vehicle, so the trained action prediction model corresponding to each game scene is different.

In the above step S103, the historical operation habit of the target player is the operation habit of the target player to control the motion vehicle during the historical time period in the manual mode, and the historical operation habit may include the following data: the third historical running data representing a moving state of the motion vehicle at each moment in the historical time period, the third historical direction adjustment instruction issued by the target player for the motion vehicle at the each moment, and the action executed by the motion vehicle at the each moment. The third historical running data includes any one or more of the following data: the position in the game scene, the moving speed, the moving angular speed, the moving acceleration, etc., at the historical moment. The third historical direction adjustment instruction is an instruction for controlling the moving direction of the motion vehicle, which is generated after the target player touches the direction adjustment control in the graphical user interface, at the historical moment. The direction adjustment controls include a left-turning direction adjustment control and a right-turning direction adjustment control, and the direction adjustment instruction includes a left-turning direction adjustment instruction and a right-turning direction adjustment instruction.

In one or more embodiments, the reward value of each action executed by the motion vehicle is predicted through the above step S102. Since the action prediction model is obtained by training according to the data of a plurality of players playing the game, the predicted reward value matches the general habits of most players, but each player still has his own small habit. Therefore, in order to improve the accuracy of determining the target action executed by the motion vehicle that the target player wants to achieve, according to the operation habit of the target player when playing the game before, personalized adjustment may be performed on the reward value of each action, and the action with the largest reward value after adjustment is determined as the action that the target player is more inclined to. Furthermore, the target action determined in this way is more in line with the operation habit and also the wish of the target player, and the accuracy of determining the target action is improved.

In the above step S104, after the target action is determined, the terminal may control the motion vehicle to execute the target action in the game scene, and display the game scene containing the motion vehicle, in the graphical user interface.

According to the controlling method for a motion vehicle in a game provided by the present disclosure, the reward value of each action is predicted for the motion vehicle controlled by the player through the trained action prediction model, and the predicted reward value of each action is relatively in line with the operation habits of most players. In order to make the prediction result more accurate, personalized adjustment may be performed on the predicted reward value of each action in combination with the historical operation habit of a single target player, so that the finally determined target action is more in line with the operation intention of the target player, and the accuracy of determining the target action is improved.

Because the solutions of the present disclosure are mainly used in the technical field of game prediction, a large amount of training data may not be obtained when training the action prediction model, therefore, in order to improve the training accuracy of the action prediction model and improve the utilization rate of the available training data, the action prediction model of the present disclosure adopts the combination of an offline reinforcement learning network and a tree model. Among them, the tree model itself has a high computational efficiency, which is better than that of the convolution network and that of the fully connected network in the traditional reinforcement learning algorithm. Moreover, in order to introduce the tree model into the reinforcement learning algorithm, and based on the currently obtained training data, it is impossible to determine the real reward value of the action corresponding to the data to be trained, so this solution adopts the combination of the value-based discrete reinforcement learning network and the tree model to form an action prediction model.

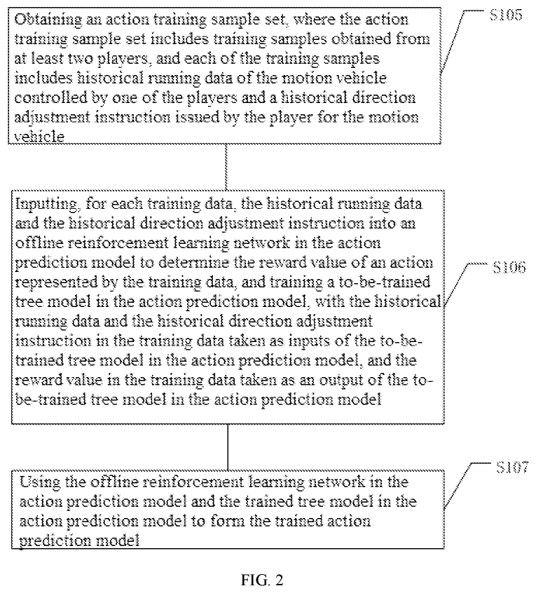

As shown in FIG. 2, the training process of the action prediction model is described in detail below.
S105: obtaining an action training sample set, where the action training sample set includes training samples obtained from at least two players, and each of the training samples includes historical running data of the motion vehicle controlled by a player and a historical direction adjustment instruction issued by the player for the motion vehicle;
S106: inputting, for each training data, the historical running data and the historical direction adjustment instruction into an offline reinforcement learning network in the action prediction model to determine the reward value of an action represented by the training data, and training the to-be-trained tree model in the action prediction model, with the historical running data and the historical direction adjustment instruction in the training data taken as inputs of the to-be-trained tree model in the action prediction model, and the reward value in the training data taken as an output of the to-be-trained tree model in the action prediction model; and
S107: using the offline reinforcement learning network in the action prediction model and the trained tree model in the action prediction model to form the trained action prediction model.

In step S105, in order to improve the training accuracy, it is necessary to train the action prediction model with a large number of training samples. Therefore, the action training sample set includes training samples obtained from a plurality of players. However, if only the training data in the automatic mode is used, the number of training samples is relatively small, so in order to increase the number and diversity of training data, the training data of players in the manual mode may also be obtained. In one or more embodiments, the action training sample set is obtained by the following steps:
obtaining, in a manual mode, first historical running data of the motion vehicle controlled by the player and a first historical direction adjustment instruction issued by the player for the motion vehicle; and
obtaining, in an automatic mode, second historical running data of the motion vehicle controlled by the player.

In one or more embodiments, the historical running data is the data in the training sample, and the historical running data includes the first historical running data and the second historical running data. The historical direction adjustment instruction is the data in the training sample, and the historical direction adjustment instruction includes the first historical direction adjustment instruction. The first historical running data and the second historical running data include any one or more of the following data: the position in the game scene, the moving speed, the moving angular speed, the moving acceleration, etc., at the historical moment. The first historical direction adjustment instruction is an instruction for controlling the moving direction of the motion vehicle, which is generated after the target player touches the direction adjustment control in the graphical user interface at the historical moment. Of course, in addition to the historical data obtained from the player in the automatic mode and the manual mode, the training data may be expanded to increase the number of training data. For example, the expansion method includes swapping the left-turning direction adjustment instruction and right-turning direction adjustment instruction in the original historical data.

In the above step S106, both the first historical running data and the second historical running data in the training data represent the corresponding motion state of the motion vehicle at the historical moment, and cannot intuitively show what the action of the motion vehicle was at that time, therefore, it is necessary to use the offline reinforcement learning network to perform data analysis according to the historical running data, to determine a reward value that can be used to represent the action corresponding to the historical running data, and then use this reward value to train the tree model. In the training process, each training data can be evaluated as good or bad. Some training data may be obtained when the player controls the motion vehicle well, and some training data may be obtained when the player controls the motion vehicle poorly. Therefore, in order to distinguish these training data and get more accurate action reward value, the wall-collision tag and the completion time of the motion vehicle in the running process corresponding to the training data may also be obtained, where the smaller the number of wall collisions is and the shorter the completion time is, the better the training data is; and the larger the number of wall collisions is and the longer the completion time is, the worse the training data is.

In the above step S107, the offline reinforcement learning network and the trained tree model may form the trained action prediction model.

After the reward value of each action is obtained through the trained action prediction model, personalized adjustment may be performed according to the historical operation habit of the target player, and the adjustment process is implemented through the sensitivity function. In one or more embodiments, step S103 includes:
step 1031: determining a sensitivity function matching the target player, according to the historical operation habit of the target player; and
step 1032: selecting the target action from the plurality of actions by using the sensitivity function and the reward value of each action.

In the above step 1031, the sensitivity function can adjust the reward value of the action output by the trained action prediction model to be more inclined to the target player's own operation habit. The sensitivity function is as follows:

$$f ( {x}_{1} , {x}_{2} , α , β ) = Sign ( {[ 1 , - β ] [ \begin{matrix}{x}_{1} \\ {x}_{2}\end{matrix} ]}^{a} ) \qquad ( Formula 1 )$$

where x₁ and x₂ are the reward values corresponding to drifting and non-drifting respectively, and α and β are the sensitivity parameters matching the historical operation habit of the target player.

In one or more embodiments, the sensitivity parameters in the sensitivity function may be adjusted by using the historical operation habit of the target player, and the sensitivity function matching the target player may be finally determined.

In one or more embodiments, the detailed steps of determining the sensitivity function matching the target player are as follows:
step 10311: obtaining a plurality of continuous pieces of third historical running data of the motion vehicle controlled by the target player in the manual mode and a real action tag corresponding to each of the pieces of third historical running data;
step 10312: determining a plurality of candidate parameter combinations from a sensitivity parameter range of a to-be-adjusted sensitivity function according to the plurality of continuous pieces of third historical running data;
step 10313: determining a target parameter combination from the plurality of candidate parameter combinations by using the third historical running data and the real action tag corresponding to each of the pieces of third historical running data; and
step 10314: adjusting sensitivity parameters of the to-be-adjusted sensitivity function by using the target parameter combination to determine the sensitivity function matching the target player.

In the above step 10311, since the sensitivity function needs to match the operation habit of the target player, it is necessary to consider the real action instruction issued by the target player to the motion vehicle, so what is obtained in this step is the historical data of the target player in the manual mode, that is, the third historical running data of the motion vehicle controlled by the target player and the real action tag corresponding to each of the pieces of third historical running data are obtained, where the real action tag matches the real action instruction issued by the target player to the motion vehicle. For example, if the real action tag is drifting, the real action instruction issued by the target player to the motion vehicle is a drifting instruction.

In the above step 10312, the sensitivity parameter range is set artificially, that is, both the α and β mentioned above have corresponding sensitivity parameter ranges.

In one or more embodiments, candidate parameter combinations are determined in the following way:
dividing the sensitivity parameter range corresponding to a according to a preset interval to obtain a plurality of interval values;
inputting the reward value of each action output in step S102 as a fixed parameter, and a plurality of interval values of α as variables, into the formula f(x₁, x₂, α, β)=0, calculating the β value corresponding to each interval value of α, and using the each interval value of α and the β value corresponding to the interval value of α to form one candidate parameter combination.

In the above step 10313, the specific steps of determining the target parameter combination are as follows:
step 103131: determining, for each of the candidate parameter combinations, the virtual action tag corresponding to each third historical running data by using the third historical running data and the candidate sensitivity function in which the candidate parameter combinations are set;
step 103132: calculating, for each of the candidate parameter combinations, a plurality of virtual action tags corresponding to the candidate parameter combination and the real action tag corresponding to each of the pieces of third historical running data, and determining a matching degree of each of the candidate parameter combinations;
step 103133: determining a candidate parameter combination with a highest matching degree as the target parameter combination.

In the above step 103131, each of the candidate parameter combinations is substituted into Formula 1, and a plurality of continuous pieces of third historical running data are input into Formula 1 in which the candidate parameter combination is substituted, so that the plurality of virtual action tags for each of the candidate parameter combinations can be obtained.

In the above step 103132, for each candidate parameter combination, the accuracy rate and the recall rate are calculated by using the plurality of virtual action tags and a plurality of real action tags, and the F value is calculated based on the accuracy rate and the recall rate. F value=accuracy rate×recall rate×2/(accuracy rate+recall rate), and the candidate parameter combination with a higher F value has a matching degree with the historical operation habit of the target player. That is, in step 103133, the candidate parameter combination with the highest matching degree is determined as the target parameter combination.

In the above step 10314, the original sensitivity parameters of the to-be-adjusted sensitivity function are replaced by the target parameter combination, and the sensitivity function matching the target player is obtained. The sensitivity parameters in the adjusted sensitivity function are determined by performing personalized adjustment for the target player according to the real data of the target player in the manual mode, thus improving the accuracy of determining the target action by the sensitivity function.

In the above step 1032, after the target parameter combination is determined, the target parameter combination is substituted into the sensitivity function, to adjust the parameters in the sensitivity function, and then the reward value of each action output by the trained action prediction model is input into the sensitivity function in which the sensitivity parameters are adjusted, to perform personalized adjustment on the reward value of each action to obtain the adjusted reward value of each action, and finally the action with the largest reward value is determined as the target action. The sensitivity function is determined based on the historical data of the target player, and then the target action determined by using the sensitivity function may be more in line with the operation habit of the target player, thus improving the accuracy of determining the target action.

Finally, even if the target action determined by the trained action prediction model and the sensitivity function is not necessarily 100% accurate, it is very likely that the drifting action is determined through the above solution when the motion vehicle is doing straight line motion, which is very irrational. Therefore, the present disclosure may delete the abnormal action that is irrational, to make the motion vehicle keep the original action. That is, the controlling method of the present disclosure further includes:
step 108: obtaining route data of a position of the motion vehicle in the game scene; and
step S104 further includes:
step 1041: controlling the motion vehicle to execute the target action in the game scene if the target action meets an execution condition under the route data; and
step 1042: controlling the motion vehicle to run according to an original action in the game scene if the target action does not meet the execution condition under the route data.

In the above step 108, the route data of the position of the motion vehicle in the game scene refers to the moving route of the motion vehicle from the initial position to the end position in the game scene, and the moving route includes bends and/or straights.

In the above steps 1041 and 1042, that the target action meets an execution condition under the route data means that the target action is a non-abnormal action in a current route, such as a non-drifting action in a straight route and a drifting action at a bend. That the target action does not meet the execution condition under route data means that the target action is an abnormal action in a current route, such as a drifting action in a straight route or a non-drifting action at a bend. If the target action is found to be abnormal, the target action needs to be eliminated in time, so that the motion vehicle runs according to the original action, thus reducing the failure of determining the target action and improving the user experience.

The present disclosure gives priority to the description of two actions: drifting and non-drifting. Of course, other actions may also be applied to this solution, such as boosting and non-boosting, braking and non-braking. However, for different actions, the corresponding parameters thereof in the action prediction model and the parameters of the sensitivity function are different, for example, the boosting and non-boosting actions correspond to one combination of action prediction model and sensitivity function, and the braking and non-braking actions correspond to one combination of action prediction model and sensitivity function. The boosting is an acceleration skill of the motion vehicle in the game scene, and braking is a travelling means of the motion vehicle in the game scene. The non-drifting, non-boosting and non-braking all refer to the normal travelling of the motion vehicle in the game scene.

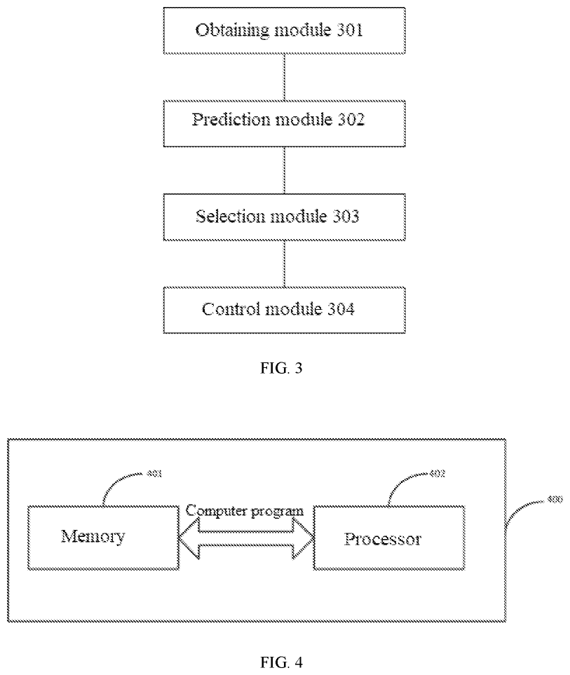

An embodiment of the present disclosure provides a controlling apparatus for a motion vehicle in a game. As shown in FIG. 3, a graphical user interface is provided through a terminal, the graphical user interface includes at least a part of a game scene and a motion vehicle controlled by a target player in the game scene. The controlling apparatus includes:
an obtaining module 301, configured for obtaining a direction adjustment instruction issued by the target player for the motion vehicle, and running data of the motion vehicle in real time;
a prediction module 302, configured for inputting the direction adjustment instruction and the running data into a trained action prediction model to predict a reward value of each action executed by the motion vehicle;
a selection module 303, configured for selecting a target action from a plurality of actions according to a historical operation habit of the target player and the reward value of each action; and
a control module 304, configured for controlling the motion vehicle to execute the target action in the game scene.

In some examples, the controlling apparatus includes:
a sample obtaining module, configured for obtaining an action training sample set, where the action training sample set includes training samples obtained from at least two players, and each of the training samples includes historical running data of the motion vehicle controlled by one of the players and a historical direction adjustment instruction issued by the player for the motion vehicle;
a training module, configured for: inputting, for each training data, the historical running data and the historical direction adjustment instruction into an offline reinforcement learning network in the action prediction model to determine the reward value of an action represented by the training data, and training a to-be-trained tree model in the action prediction model, with the historical running data and the historical direction adjustment instruction in the training data taken as inputs of the to-be-trained tree model in the action prediction model, and the reward value in the training data taken as an output of the to-be-trained tree model in the action prediction model; and
a combination module, configured for using the offline reinforcement learning network in the action prediction model and the trained tree model in the action prediction model to form the trained action prediction model.

In some examples, the sample obtaining module includes:
a first obtaining unit, configured for obtaining, in a manual mode, first historical running data of the motion vehicle controlled by the player and a first historical direction adjustment instruction issued by the player for the motion vehicle; and
a second obtaining unit, configured for obtaining, in an automatic mode, second historical running data of the motion vehicle controlled by the player.

In some examples, the selection module includes:
a first determination unit, configured for determining a sensitivity function matching the target player, according to the historical operation habit of the target player; and
a selection unit, configured for selecting the target action from the plurality of actions by using the sensitivity function and the reward value of each action.

In some examples, the determination unit includes:
a third obtaining unit, configured for obtaining a plurality of continuous pieces of third historical running data of the motion vehicle controlled by the target player in the manual mode and a real action tag corresponding to each of the pieces of third historical running data;
a second determination unit, configured for determining a plurality of candidate parameter combinations from a sensitivity parameter range of a to-be-adjusted sensitivity function according to the plurality of continuous pieces of third historical running data;
a third determination unit, configured for determining a target parameter combination from the plurality of candidate parameter combinations by using the third historical running data and the real action tag corresponding to each of the pieces of third historical running data; and
a fourth determination unit, configured for adjusting sensitivity parameters of the to-be-adjusted sensitivity function by using the target parameter combination to determine the sensitivity function matching the target player.

In some examples, the third determination unit includes:
a first determination subunit, configured for: determining, for each of the candidate parameter combinations, a virtual action tag corresponding to each of the pieces of third historical running data by using the third historical running data and a candidate sensitivity function in which the candidate parameter combinations are set;
a second determination subunit, configured for: calculating, for each of the candidate parameter combinations, a plurality of virtual action tags corresponding to the candidate parameter combination and the real action tag corresponding to each of the pieces of third historical running data, and determining a matching degree of each of the candidate parameter combinations with the historical operation habit of the target player; and
a third determination subunit, configured for determining a candidate parameter combination with a highest matching degree as the target parameter combination.

In some examples, the controlling apparatus further includes:
a route obtaining module, configured for obtaining route data of a position of the motion vehicle in the game scene; and
a control module, which includes:
a judging unit, configured for: controlling the motion vehicle to execute the target action in the game scene if the target action meets an execution condition under the route data; and controlling the motion vehicle to run according to an original action in the game scene if the target action does not meet the execution condition under the route data.

Corresponding to the controlling method for a motion vehicle in a game in FIG. 1, an embodiment of the present disclosure further provides a computer device 400. As shown in FIG. 4, the device includes a memory 401, a processor 402 and a computer program stored on the memory 401 and executable on the processor 402, where the processor 402 performs the controlling method for a motion vehicle in a game when executing the computer program. The controlling apparatus includes:
obtaining a direction adjustment instruction issued by the target player for the motion vehicle, and running data of the motion vehicle in real time;
inputting the direction adjustment instruction and the running data into a trained action prediction model to predict a reward value of each action executed by the motion vehicle;
selecting a target action from a plurality of actions according to a historical operation habit of the target player and the reward value of each action; and
controlling the motion vehicle to execute the target action in the game scene.

In some examples, the action prediction model is trained by the following steps:
obtaining an action training sample set, where the action training sample set includes training samples obtained from at least two players, and each of the training samples includes historical running data of the motion vehicle controlled by one of the players and a historical direction adjustment instruction issued by the player for the motion vehicle;
inputting, for each training data, the historical running data and the historical direction adjustment instruction into an offline reinforcement learning network in the action prediction model to determine the reward value of an action represented by the training data, and training a to-be-trained tree model in the action prediction model, with the historical running data and the historical direction adjustment instruction in the training data taken as inputs of the to-be-trained tree model in the action prediction model, and the reward value in the training data taken as an output of the to-be-trained tree model in the action prediction model; and
using the offline reinforcement learning network in the action prediction model and the trained tree model in the action prediction model to form the trained action prediction model.

In some examples, the action training sample set is obtained by the following steps:
obtaining, in a manual mode, first historical running data of the motion vehicle controlled by the player and a first historical direction adjustment instruction issued by the player for the motion vehicle; and
obtaining, in an automatic mode, second historical running data of the motion vehicle controlled by the player.

In some examples, the selecting a target action from a plurality of actions according to a historical operation habit of the target player and the reward value of each action includes:
determining a sensitivity function matching the target player, according to the historical operation habit of the target player; and
selecting the target action from the plurality of actions by using the sensitivity function and the reward value of each action.

In some examples, the determining a sensitivity function matching the target player according to the historical operation habit of the target player includes:
obtaining a plurality of continuous pieces of third historical running data of the motion vehicle controlled by the target player in the manual mode and a real action tag corresponding to each of the pieces of third historical running data;
determining a plurality of candidate parameter combinations from a sensitivity parameter range of the to-be-adjusted sensitivity function according to the plurality of continuous pieces of third historical running data;
determining a target parameter combination from the plurality of candidate parameter combinations by using the third historical running data and the real action tag corresponding to each of the pieces of third historical running data; and
adjusting sensitivity parameters of the to-be-adjusted sensitivity function by using the target parameter combination to determine the sensitivity function matching the target player.

In some examples, the determining a target parameter combination from the plurality of candidate parameter combinations by using the third historical running data and the real action tag corresponding to each of the pieces of third historical running data includes:
determining, for each of the candidate parameter combinations, a virtual action tag corresponding to each of the pieces of third historical running data by using the third historical running data and a candidate sensitivity function in which the candidate parameter combinations are set;
calculating, for each of the candidate parameter combinations, a plurality of virtual action tags corresponding to the candidate parameter combinations and the real action tag corresponding to each of the pieces of third historical running data, and determining a matching degree of each of the candidate parameter combinations with the historical operation habit of the target player; and
determining a candidate parameter combination with a highest matching degree as the target parameter combination.

In some examples, the controlling method further includes:
obtaining route data of a position of the motion vehicle in the game scene; and
the controlling the motion vehicle to execute the target action in the game scene includes:
controlling the motion vehicle to execute the target action in the game scene if the target action meets an execution condition under the route data; and
controlling the motion vehicle to run according to an original action in the game scene if the target action does not meet the execution condition under the route data.

In one or more embodiments, the above memory 401 and the processor 402 may be a general memory and a general processor, which are not specifically limited here. When the processor 402 runs the computer program stored on the memory 401, the controlling method for a motion vehicle in a game can be performed, which solves the problem that the target action of the motion vehicle controlled by a target player cannot be accurately predicted in the related technologies. According to the present disclosure, the reward value of each action is predicted for the motion vehicle controlled by the player through the trained action prediction model, and the predicted reward value of each action is relatively in line with the operation habits of most players. In order to make the prediction result more accurate, personalized adjustment may be performed on the predicted reward value of each action in combination with the historical operation habit of a single target player, so that the finally determined target action is more in line with the operation intention of the target player, improving the accuracy of determining the target action.

Corresponding to the controlling method for a motion vehicle in a game in FIG. 1, an embodiment of the present disclosure further provides a computer-readable storage medium, a computer program is stored on the computer-readable storage medium, and when the computer program is run by a processor, the controlling method for a motion vehicle in a game as described above is performed. The controlling method includes:
obtaining a direction adjustment instruction issued by the target player for the motion vehicle, and running data of the motion vehicle in real time;
inputting the direction adjustment instruction and the running data into a trained action prediction model to predict a reward value of each action executed by the motion vehicle;
selecting a target action from a plurality of actions according to a historical operation habit of the target player and the reward value of each action; and
controlling the motion vehicle to execute the target action in the game scene.

In some examples, the action prediction model is trained by the following steps:
obtaining an action training sample set, where the action training sample set includes training samples obtained from at least two players, and each of the training samples includes historical running data of the motion vehicle controlled by one of the players and a historical direction adjustment instruction issued by the player for the motion vehicle;
inputting, for each training data, the historical running data and the historical direction adjustment instruction into an offline reinforcement learning network in the action prediction model to determine the reward value of an action represented by the training data, and training a to-be-trained tree model in the action prediction model, with the historical running data and the historical direction adjustment instruction in the training data taken as inputs of the to-be-trained tree model in the action prediction model, and the reward value in the training data taken as an output of the to-be-trained tree model in the action prediction model; and
using the offline reinforcement learning network in the action prediction model and the trained tree model in the action prediction model to form the trained action prediction model.

In some examples, the action training sample set is obtained by the following steps:
obtaining, in a manual mode, first historical running data of the motion vehicle controlled by the player and a first historical direction adjustment instruction issued by the player for the motion vehicle; and
obtaining, in an automatic mode, second historical running data of the motion vehicle controlled by the player.

In some examples, the selecting a target action from a plurality of actions according to a historical operation habit of the target player and the reward value of each action includes:
determining a sensitivity function matching the target player, according to the historical operation habit of the target player; and
selecting the target action from the plurality of actions by using the sensitivity function and the reward value of each action.

In some examples, the determining a sensitivity function matching the target player according to the historical operation habit of the target player includes:
obtaining a plurality of continuous pieces of third historical running data of the motion vehicle controlled by the target player in the manual mode and a real action tag corresponding to each of the third historical running data;
determining a plurality of candidate parameter combinations from a sensitivity parameter range of a to-be-adjusted sensitivity function according to the plurality of continuous pieces of third historical running data;
determining a target parameter combination from the plurality of candidate parameter combinations by using the third historical running data and the real action tag corresponding to each of the pieces of third historical running data; and
adjusting sensitivity parameters of the to-be-adjusted sensitivity function by using the target parameter combination to determine the sensitivity function matching the target player.

In some examples, the determining a target parameter combination from the plurality of candidate parameter combinations by using the third historical running data and the real action tag corresponding to each of the pieces of third historical running data includes:
determining, for each of the candidate parameter combinations, a virtual action tag corresponding to each of the pieces of third historical running data by using the third historical running data and a candidate sensitivity function in which the candidate parameter combinations are set;
calculating, for each of the candidate parameter combinations, a plurality of virtual action tags corresponding to the candidate parameter combinations and the real action tag corresponding to each of the pieces of third historical running data, and determining a matching degree of each of the candidate parameter combinations with the historical operation habit of the target player; and
determining a candidate parameter combination with a highest matching degree as the target parameter combination.

In some examples, the controlling method further includes:
obtaining route data of a position of the motion vehicle in the game scene; and
the controlling the motion vehicle to execute the target action in the game scene includes:
controlling the motion vehicle to execute the target action in the game scene if the target action meets an execution condition under the route data; and
controlling the motion vehicle to run according to an original action in the game scene if the target action does not meet the execution condition under the route data.

Specifically, the storage medium may be a general storage medium, such as a mobile disk, a hard disk, etc. When the computer program on the storage medium is run, the controlling method for a motion vehicle in a game can be performed, which solves the problem that the target action of the motion vehicle controlled by a target player cannot be accurately predicted in the related technologies. According to the present disclosure, the reward value of each action is predicted for the motion vehicle controlled by the player through the trained action prediction model, and the predicted reward value of each action is relatively in line with the operation habits of most players. In order to make the prediction result more accurate, personalized adjustment may be performed on the predicted reward value of each action in combination with the historical operation habit of a single target player, so that the finally determined target action is more in line with the operation intention of the target player, improving the accuracy of determining the target action.

From the embodiments provided by the present disclosure, it should be understood that the disclosed methods and apparatuses may be implemented in other ways. The above-described apparatus embodiments are only schematic. For example, the division of the units is only a logical function division, and there may be another division mode in actual implementation. For another example, a plurality of units or components may be combined or integrated into another system, or some features may be ignored or not performed. On the other hand, the shown or discussed mutual coupling or direct coupling or communication may be indirect coupling or communication through some communication interfaces, apparatuses or units, which may be electrical, mechanical or in other forms.

The units described as separate parts may or may not be physically separated, and the parts displayed as units may or may not be physical units, that is, they may be located in one place or distributed over a plurality of network units. Some or all of the units may be selected according to the actual needs to achieve the objective of solutions of the embodiments.

In addition, each functional unit in the embodiments provided by the present disclosure may be integrated in one processing unit, or each unit may physically exist separately, or two or more units may be integrated in one unit.

If the functions are implemented in the form of software functional units and sold or used as independent products, they may be stored in a computer-readable storage medium. Based on this understanding, the essential part of the technical solutions of the present disclosure or the part that contributes to the related technologies or part of the technical solutions may be embodied in the form of a software product. The computer software product is stored in a storage medium and includes a number of instructions to make a computer device (which may be a personal computer, a server, or a network device, etc.) perform all or some of the steps of the methods described in various embodiments of the present disclosure. The aforementioned storage medium includes: a U disk, a mobile hard disk, a read-only memory (ROM), a random access memory (RAM), a magnetic disk or an optical disk and other media that can store program codes.

It should be noted that similar reference numerals and letters indicate similar items in the following drawings, so once a certain item is defined in one drawing, it does not need to be further defined and described in subsequent drawings. In addition, the terms “first”, “second” and “third”, etc. are only intended for distinguishing descriptions, and cannot be understood as indicating or implying importance in relativity.

Finally, it should be noted that the above-mentioned embodiments are only specific embodiments of the present disclosure, which are intended to illustrate, but not to limit the technical solutions of the present disclosure, and the scope of protection of the present disclosure is not limited to these embodiments. Although the present disclosure has been illustrated in detail with reference to the aforementioned embodiments, those ordinarily skilled in the art should understand that any person ordinarily skilled in the art may still modify or easily think of changes to the technical solutions described in the aforementioned embodiments within the technical scope disclosed in the present disclosure, or make equivalent substitution of some of the technical features. However, these modifications, changes or substitutions do not make the essence of the corresponding technical solutions deviate from the spirit and scope of the technical solutions of the embodiments of the present disclosure, and shall fall within the scope of protection of the present disclosure. Therefore, the scope of protection of the present disclosure shall be subject to the scope of protection of the claims.

1-10. (canceled)

11. A method for controlling a motion vehicle in a game, comprising:
obtaining, by a terminal, a direction adjustment instruction issued by a target player for the motion vehicle and running data of the motion vehicle in real time, wherein a graphical user interface is provided through the terminal, and at least a part of a game scene and the motion vehicle controlled by the target player in the game scene are displayed in the graphical user interface;
inputting the direction adjustment instruction and the running data into a trained action prediction model to predict a reward value of each action executed by the motion vehicle;
selecting a target action from a plurality of actions according to a historical operation habit of the target player and the reward value of each action; and
controlling the motion vehicle to execute the target action in the game scene.

12. The method of claim 11, wherein the action prediction model is trained by:
obtaining an action training sample set, wherein the action training sample set comprises training samples obtained from at least two players, and each of the training samples comprises historical running data of the motion vehicle controlled by one of the at least two players and a historical direction adjustment instruction issued by the player for the motion vehicle;
inputting, for each training data, the historical running data and the historical direction adjustment instruction into an offline reinforcement learning network in the action prediction model to determine a reward value of an action represented by the training data, and training a to-be-trained tree model in the action prediction model, with the historical running data and the historical direction adjustment instruction in the training data taken as inputs of the to-be-trained tree model in the action prediction model, and the reward value in the training data taken as an output of the to-be-trained tree model in the action prediction model; and
using the offline reinforcement learning network in the action prediction model and the trained tree model in the action prediction model to form the trained action prediction model.

13. The method of claim 12, wherein the action training sample set is obtained by:
obtaining, in a manual mode, first historical running data of the motion vehicle controlled by the player and a first historical direction adjustment instruction issued by the player for the motion vehicle; and
obtaining, in an automatic mode, second historical running data of the motion vehicle controlled by the player.

14. The method of claim 11, wherein selecting the target action from the plurality of actions according to the historical operation habit of the target player and the reward value of each action comprises:
determining a sensitivity function matching the target player according to the historical operation habit of the target player; and
selecting the target action from the plurality of actions by using the sensitivity function and the reward value of each action.

15. The method of claim 14, wherein determining the sensitivity function matching the target player according to the historical operation habit of the target player comprises:
obtaining a plurality of continuous pieces of third historical running data of the motion vehicle controlled by the target player in a manual mode and a real action tag corresponding to each of the pieces of third historical running data;
determining a plurality of candidate parameter combinations from a sensitivity parameter range of a to-be-adjusted sensitivity function according to the plurality of continuous pieces of third historical running data;
determining a target parameter combination from the plurality of candidate parameter combinations by using the third historical running data and the real action tag corresponding to each of the pieces of third historical running data; and
adjusting sensitivity parameters of the to-be-adjusted sensitivity function by using the target parameter combination to determine the sensitivity function matching the target player.

16. The method of claim 15, wherein determining the target parameter combination from the plurality of candidate parameter combinations by using the third historical running data and the real action tag corresponding to each of the third historical running data comprises:
determining, for each of the candidate parameter combinations, a virtual action tag corresponding to each of the pieces of third historical running data, by using the third historical running data and a candidate sensitivity function in which the candidate parameter combinations are set;
calculating, for each of the candidate parameter combinations, a plurality of virtual action tags corresponding to the candidate parameter combination and the real action tag corresponding to each of the pieces of third historical running data, and determining a matching degree of each of the candidate parameter combinations with the historical operation habit of the target player; and
determining a candidate parameter combination with a highest matching degree, as the target parameter combination.

17. The method according to claim 16, wherein the sensitivity function is configured to adjust the reward value of the each action to be inclined to the operation habit of the target player, and a formula of the sensitivity function is:
$$f ( x \_ 1 , x \_ 2 , α , β 〉 = Sign ( [ 1 , - β ] [ ◼ ( x \_ 1 @ x \_ 2 ) ] {}^{∧} α ) .$$

18. The method according to claim 17, wherein determining the plurality of candidate parameter combinations from the sensitivity parameter range of the to-be-adjusted sensitivity function according to the plurality of continuous pieces of third historical running data comprises:
dividing the sensitivity parameter range corresponding to a according to a preset interval to obtain a plurality of interval values; and
inputting the reward value of the each action as a fixed parameter, and the plurality of interval values of a as variables, into a formula f(x_1, x_2, α,β)=0, calculating a β value corresponding to each of the plurality interval values of, and using the each interval value of α and the corresponding β value to form one candidate parameter combination.

19. The method according to claim 17, wherein determining for each of the candidate parameter combinations the virtual action tag corresponding to each of the pieces of third historical running data by using the third historical running data and the candidate sensitivity function in which the candidate parameter combinations are set comprises:
substituting each of the candidate parameter combinations into the formula of the sensitivity function, and then inputting the plurality of continuous pieces of third historical running data into the formula of the sensitivity function, to obtain the plurality of virtual action tags for each of the candidate parameter combination.

20. The method according to claim 17, wherein calculating for each of the candidate parameter combinations the plurality of virtual action tags corresponding to the candidate parameter combination and the real action tag corresponding to each of the pieces of third historical running data and determining the matching degree of each of the candidate parameter combinations with the historical operation habit of the target player comprises:
calculating, for each of the candidate parameter combinations, an accuracy rate and a recall rate by using the virtual action tags and the real action tags; and
calculating an F value based on the accuracy rate and the recall rate.

21. The method according to claim 15, wherein adjusting the sensitivity parameters of the to-be-adjusted sensitivity function by using the target parameter combination to determine the sensitivity function matching the target player comprises:
replacing original sensitivity parameters of the to-be-adjusted sensitivity function with the target parameter combination to obtain the sensitivity function matching the target player.

22. The method according to claim 15, wherein selecting the target action from the plurality of actions by using the sensitivity function and the reward value of each action comprises:
substituting the target parameter combination into the sensitivity function to adjust parameters in the sensitivity function;
inputting the reward value of each action output by the trained action prediction model into the sensitivity function to perform personalized adjustment on the reward value of each action to obtain adjusted reward value of each action; and
determining an action with a largest reward value as the target action.

23. The method according to claim 15, wherein the real action tag matches a real action instruction issued by the target player to the motion vehicle.

24. The method of claim 11, further comprising:
obtaining route data of a position of the motion vehicle in the game scene;
wherein the controlling the motion vehicle to execute the target action in the game scene comprises:
controlling the motion vehicle to execute the target action in the game scene, in response to that the target action meets an execution condition under the route data; and
controlling the motion vehicle to run according to an original action in the game scene, in response to that the target action does not meet the execution condition under the route data.

25. The method according to claim 24, wherein the route data of the position of the motion vehicle in the game scene refers to a moving route of the motion vehicle from an initial position to an end position in the game scene.

26. The method according to claim 24, wherein that the target action meets an execution condition under the route data means that the target action is a non-abnormal action in a current route; and that the target action does not meet the execution condition under the route data means that the target action is an abnormal action in a current route.

27. The method according to claim 11, wherein the running data of the motion vehicle comprises at least one of a position in the game scene, a moving speed, a moving angular speed, or a moving acceleration.

28. The method according to claim 11, wherein the direction adjustment instruction is generated after the target player touches a direction adjustment control in the graphical user interface and configured to control a moving direction of the motion vehicle.

29. A computer device, comprising a memory, a processor, and a computer program stored on the memory and executable by the processor, wherein the processor is configured to control a motion vehicle in a game when executing the computer program, wherein executing the computer program causes the processor to:
obtain a direction adjustment instruction issued by a target player for the motion vehicle and running data of the motion vehicle in real time, wherein a graphical user interface is provided through the computer device, and at least a part of a game scene and the motion vehicle controlled by a target player in the game scene are displayed in the graphical user interface;
input the direction adjustment instruction and the running data into a trained action prediction model to predict a reward value of each action executed by the motion vehicle;
select a target action from a plurality of actions according to a historical operation habit of the target player and the reward value of each action; and
control the motion vehicle to execute the target action in the game scene.

30. A non-transitory computer-readable storage medium, wherein a computer program is stored on the non-transitory computer-readable storage medium, and when the computer program is run by a processor, cause the processor to:
obtain, by a terminal, a direction adjustment instruction issued by a target player for the motion vehicle and running data of the motion vehicle in real time, wherein a graphical user interface is provided through the terminal, and at least a part of a game scene and the motion vehicle controlled by a target player in the game scene are displayed in the graphical user interface;
input the direction adjustment instruction and the running data into a trained action prediction model to predict a reward value of each action executed by the motion vehicle;
select a target action from a plurality of actions according to a historical operation habit of the target player and the reward value of each action; and
control the motion vehicle to execute the target action in the game scene.
